(19) United States
(12) Patent Application Publication
(10) Pub. No.: US 2003/0088874 A1
(43) Pub. Date: May 8, 2003

(54) Interactive digital television network

(75) Inventors: Pascal Bazin, Clichy Sous Bois (FR); Jean Roger Despatin, La Colle Sur Loup (FR); Thierry Gruszka, Paris (FR); Patrick Laffitte, Joinville Le Pont (FR)

Correspondence Address: YOUNG & THOMPSON, 745 SOUTH 23RD STREET 2ND FLOOR, ARLINGTON, VA, 22202

(73) Assignee: INTERACTIF DELTA PRODUCTION

(21) Appl. No.: 09/888,566

(22) Filed: Jun. 26, 2001

(30) Foreign Application Priority Data
Jun. 27, 2000 (FR) 00 08218

(51) Int. Cl. H04N 7/173

(52) U.S. Cl. 725/86; 725/105

(57) ABSTRACT

An interactive digital television network includes broadcaster site (1) connected by a broadcasting channel (16, 10, 34) to at least one customer station (4). The broadcaster site (1) chiefly comprises a center for agencies (4) which mobilize resources (5) for implementing projects (6) with the aid of target profiles (7) destined for a generator or transcoder (11) which interprets the programs of an interactive digital television application in a multi-platform low-level language. The customer stations essentially comprise a reader (26) of the programs which execute each program with the aid of a digital television platform (29), the program executed having been transcoded as a function of the target platform.

The present invention relates to a digital television network, a private television network in particular, for making, broadcasting and monitoring interactive television programmes.

In the state of the art, there are solutions making it possible to produce digital television programmes which are broadcast over broadcasting networks such as cables, or over the airwaves, to receivers of digital television programmes. In such programmes, several types of digital data may be exchanged. These consist chiefly of picture data, picture sequences, sounds, sound sequences, texts, graphics, commands and monitoring messages. The production of such a programme therefore requires the manipulation within the framework of a command language of a large number of different types of data. Moreover, it must be possible to implement complete applications comprising several programmes, broadcast to different users, to modify existing programmes and other characteristics.

The present invention makes it possible to implement a digital television network, of the kind comprising at least one broadcaster computer comprising data storage means and means for transmitting digital television applications, and at least one device for executing at least one digital television application. It is characterized in particular in that the network comprises:

an agencies centre installed on at least the broadcaster computer so as to create, modify and/or broadcast a television application;

a transcoder or generator for transcoding the digital television applications emanating from the agencies centre;

consoles for which the applications emanating from the transcoder and broadcast by at least one broadcasting channel are destined.

According to another aspect, the invention relates to a network characterized in that the agencies centre comprises:

an agencies manager comprising a means of activating one at least of the agencies;

a media agency comprising means for editing, in particular retrieving means, centralizing means, and archiving means, and means for organizing the elements intended to make up at least one digital television application,

a programmes agency comprising means for composing a digital television application according to a predefinable tree and predefinable navigation, means for updating an application and means for determining broadcasting rules cooperating with means for producing programme execution lists (playlists) and with means for indexing and archiving the programmes and/or execution lists;

a sites agency comprising means for distributing and means for broadcasting programmes created or updated in the programmes agency.

According to another aspect, the invention relates to a network, characterized in that each agency comprises:

a menu bar;

a hierarchical list;

a properties zone for the elements selected from the agency;

a contents display zone.

According to another aspect, the invention relates to a network, characterized in that the properties zone of each agency comprises:

a zone of types of elements to be selected,

a zone for editing the name of the element to be selected;

a zone for editing the values of the properties of the selected element.

According to another aspect, the invention relates to a network, characterized in that the content display zone for each agency comprises control means for selecting a mode of display in Table form, in Zoom form, in Caption form and in single or multiple Selection mode.

According to another aspect, the invention relates to a network, characterized in that the agencies manager also comprises an access rights manager which limits access of the agencies centre to the resources and target profiles according to the set where it is installed.

According to another aspect, the invention relates to a network, characterized in that the media agency comprises means for executing one at least of the following functions:

ASSOCIATE: for filling in an element of another agency with the content of the medium;

EDIT: for modifying the content of the medium;

REPLACE: for changing the physical file of the medium.

According to another aspect, the invention relates to a network, characterized in that the media agency also comprises means for executing at least one of the following functions: Display, New, New/Folder, New/Medium, Rename/Modify, Delete, Copy, Duplicate, Move, Export, Import, Add, Add/Video, Add/Picture, Add/Audio, Add/Text, Add/File, Replace.

According to another aspect, the invention relates to a network, characterized in that the media agency comprises means for processing one at least of the following objects: Folder, Video, Picture, Sound, Text, Internet file, database file.

According to another aspect, the invention relates to a network, characterized in that the programmes agency comprises means for executing one at least of the following functions:

GENERATE for initiating the generation of the source code and sending it to the generator;

DISPLAY for displaying the scene such as on a TV screen;

MEDIA AGENCY for opening the media agency while automatically pointing to the medium associated with the current element;

CHANGE MEDIUM for selecting another medium from the media agency and associating it with the current element;

EDIT THE CONTENT for creating or modifying the content of the associated medium and hence of the current element;

EMPTY THE CONTENT for breaking the link-up between associated medium and the current element.

According to another aspect, the invention relates to a network, characterized in that the programmes agency also comprises means for executing at least one of the following functions: Display, New, New/Folder, New/Element, New/Programme, Rename/Modify, Delete, Delete the link-ups, Copy, Paste, Duplicate, Move, Export, Import, Medium, Content, and others still.

According to another aspect, the invention relates to a network, characterized in that the programmes agency comprises means for processing one at least of the following objects: Folder, PLAYLIST execution list, TIMED PLAYLIST synchronized execution list, “CITYLINE” interactive directory, Catalogue, Module for executing programme lists (JUKE-BOX), Advertisements insertion module (ADS-INSERT), Training, Module for managing stock market programmes (INFO-STOCK), Weather Services, electronic commerce (e-commerce), electronic banking (e-bank), electronic magazine (e-zine), and others still.

According to another aspect, the invention relates to a network, characterized in that the programmes agency comprises means for processing one at least of the following elements: Structure, Video, Sound, Picture, Text, Design, Page, List, Slide Show, Scene, Routing, Instruction, Button, and others still.

According to another aspect, the invention relates to a network, characterized in that the agencies centre and the generator are installed on at least two separate sets or stations connected by a communications network.

According to another aspect, the invention relates to a network, characterized in that the agencies centre 4 is distributed between at least one main agency (61) and one or more secondary agencies (61-1 to 61-n) on at least one implementation system.

According to another aspect, the invention relates to a network, characterized in that the codes generator cooperates in a production system with a General agency for the generation of the applications and with a module for managing the data and real-time streams.

According to another aspect, the invention relates to a network, characterized in that the production system is connected by a bidirectional link with a Distribution system comprising in particular a stream server itself connected to at least one broadcasting network with customer stations.

According to another aspect, the invention relates to a network, characterized in that the codes generator comprises means for processing each digital television application, which itself comprises:

means for processing parameters individual to each application and valid for all the other component elements such as TV Objects;

means for processing broadcasting parameters making it possible to identify the channel on the customer station;

means for processing screens of the application;

means for processing data of the application.

According to another aspect, the invention relates to a network, characterized in that the means for processing data of the application comprise:

means for processing an application Name;

means for processing an application ID identifier;

means for processing a Palette identifying the colours of TV Objects displayed;

means for processing a code for access to the application being broadcast (DVB trio);

means for processing a List of TV scenes each of a type chosen from among:

single scenes;

multipage scenes;

scenes with menu-list.

According to another aspect, the invention relates to a network, characterized in that the means for processing a list of TV scenes also comprise means for processing at least one single scene which comprise:

means for processing a Name designating the scene;

means for processing a Duration of display of the scene;

means for processing a List of TV Objects making up the scene.

According to another aspect, the invention relates to a network, characterized in that the means for processing a list of TV scenes also comprise means for processing at least one multipage scene which comprise:

means for processing a Name designating the scene;

means for processing a Duration of display of the scene;

means for processing a List of TV Objects making up at least one page of the scene;

means for processing a List of TV pages making up the scene.

According to another aspect, the invention relates to a network, characterized in that the means for processing a list of TV scenes also comprise means for processing at least one multipage scene which comprise:

means for processing a Name designating the scene;

means for processing a Duration of display of the scene;

means for processing a List of TV Objects making up at least one page of the scene;

means for processing a List of TV menu-lists making up the scene.

According to another aspect, the invention relates to a network, characterized in that the means for processing a List of TV pages making up the scene comprise means for processing at least one TV page which comprise:

means for processing the Name designating the TV page;

means for processing a Duration of display of the TV page;

means for processing a List of TV Objects individual to the TV page.

According to another aspect, the invention relates to a network, characterized in that the means for processing a List of TV menu-lists making up the scene comprise means for processing at least one TV menu-list which comprise:

means for processing a List name of the TV menu-list;

means for processing a List of TV headings;

means for processing a List of TV Objects individual to the TV scene with which the TV menu-list is associated.

According to another aspect, the invention relates to a network, characterized in that the means for processing a List of TV headings also comprise:

means for processing a heading Name of the associated TV menu-list;

means for processing a List of TV Objects representing the heading;

means for processing a TV Object containing the TV page definition associated with the heading.

According to another aspect, the invention relates to a network, characterized in that the means for processing a TV Object or lists of TV Objects manipulate one of the types of TV Objects selected from among: text objects, design objects, picture objects, routing objects, instruction objects.

According to another aspect, the invention relates to a network, characterized in that the generator or transcoder comprises means for splitting into unit blocks compatible with the constraints of the target systems the programmes emanating from the implementation and/or production agencies, each unit block corresponding to a scene, and in that it comprises means for producing as a function of each unit block a plurality of programme lines in low-level language, each television programme line comprising at least one of the following elements:

identification;

type;

content;

properties;

link-ups.

Other characteristics and advantages of the present invention will be better understood with the aid of the description which contains tables of which the text forms part and appended drawings which are:

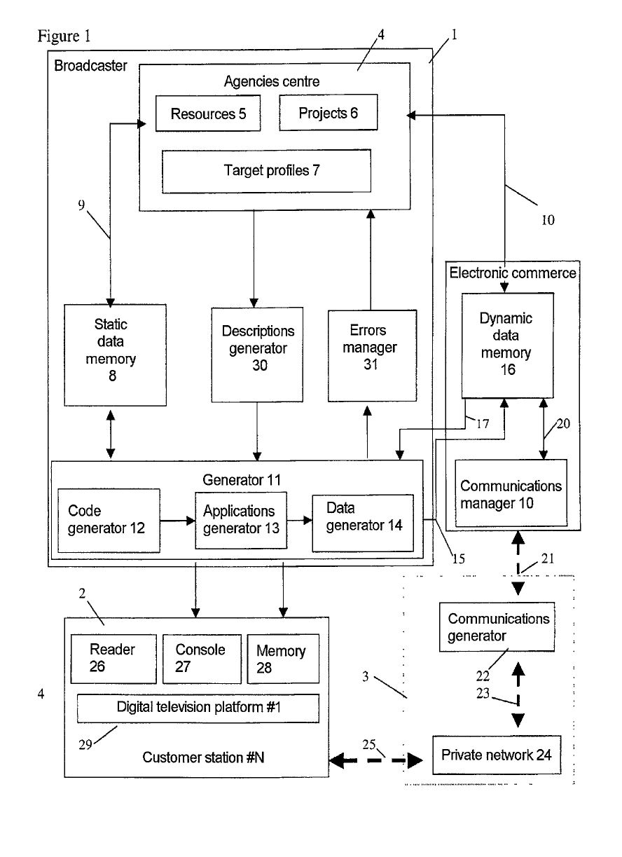

FIG. 1 : a general diagram of a digital television network according to a preferred embodiment of the invention;

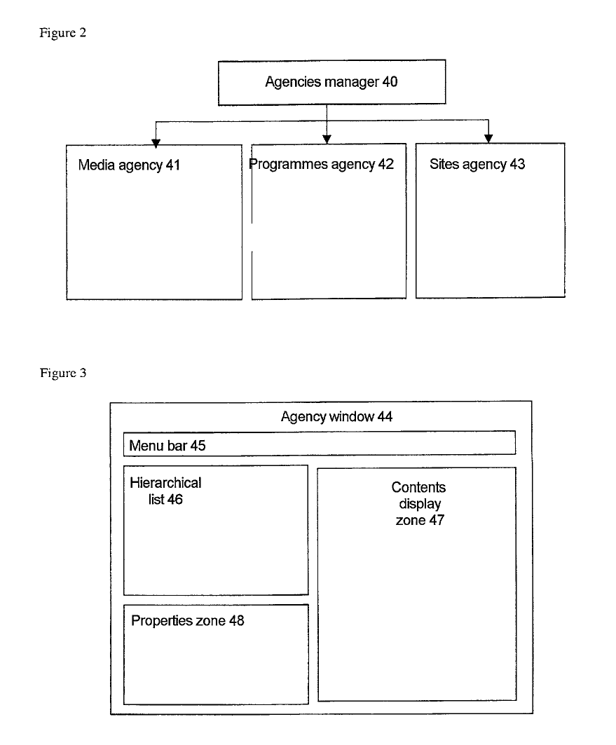

FIG. 2 : a block diagram of an agencies manager in the embodiment of FIG. 1;

FIG. 3 : a diagram of a part of an agencies manager in the embodiment of FIG. 1;

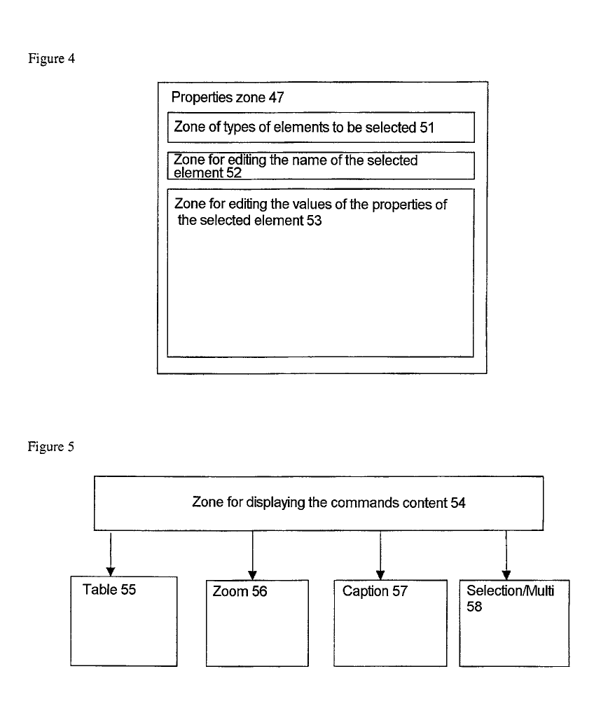

FIG. 4: a diagram of another part of an agencies manager in the embodiment of FIG. 1;

FIG. 5 : a diagram of another part of an agencies manager in the embodiment of FIG. 1;

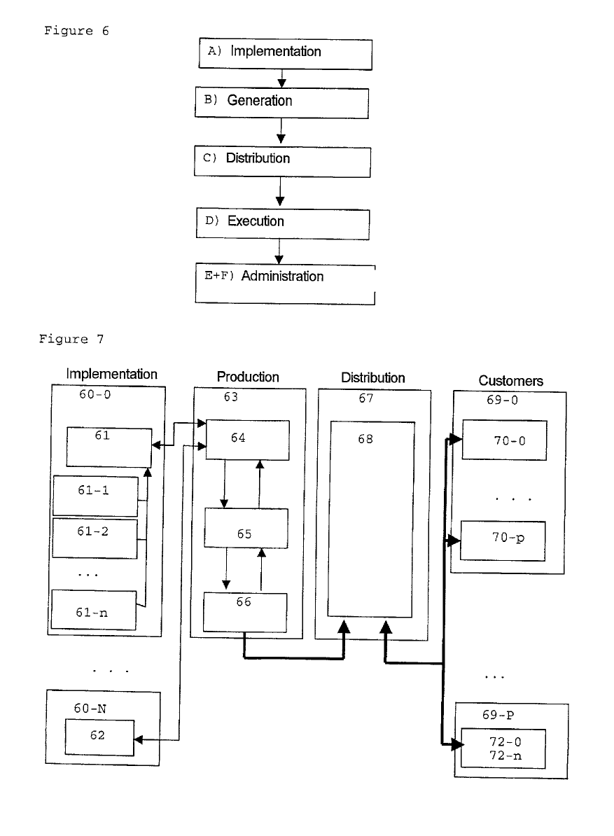

FIG. 6 : a flowchart for utilizing a television network in the configuration of the embodiment of FIG. 1;

FIG. 7 : a block diagram of another embodiment of the invention.

### I. VOCABULARY

In the subsequent description, the following terminology is used:

“Software”, a particular application generally dedicated to the implementation of or to the assistance with known tasks (compatibility of exchanges, text processing, etc.),

“Application”, a computer means which executes a collection of tasks in response to commands from a remote control, a keypad, or more generally an input system,

“Programme”, an interactive, audiovisual sequence, such as a game or a film, for implementing known tasks and/or for broadcasting a continuous audiovisual sequence,

“Interactive”, the quality of a computer object of intervening in the running of an application or of a programme (as opposed to a film for example, which runs continuously and uninterruptibly),

“Execution list”, an ordered list of programmes intended to be broadcast on an audiovisual support: television programme, CD-ROM-type optical disk, etc.

“Programming”, the equivalent of an Execution list, but including the concept of time scheduling (programming of television channels is one example of this),

“Element”, the generic term designating concepts, objects manipulated on the television network of the invention (more particularly, in the programmes agency, the elements are the components of the programmes), such as TV Objects,

“Content”, the generic term designating the source, the subject matter of a medium: text, pictures, sounds, videos,

“Media”, the generic term designating computer files containing sources of text, picture, sound and video type, emanating from multimedia means, that is to say those deploying elements originating from various media.

II. Structure of the Network

The components of a network according to one embodiment of the invention, as represented in FIG. 1, will now be described.

The digital television network of the embodiment comprises a broadcaster computer 1 equipped with known office resources. The broadcaster 1 executes an application which makes it possible to produce, edit and broadcast digital television programmes to the consoles constituting the Stations of the customers 2 of the network. Each Customer station is connected up to the network by any suitable communication channel 3.

The broadcaster 1 can comprise one or more computers working in tandem, especially in a local area network, a worldwide network such as the Internet in an external version (web or ftp) or internal version (Intranet).

An application designated by the expression “agencies centre” 4 which mobilizes computer resources 5 for building projects 6 as a function of target profiles 7 is executed on the broadcaster 1. The agencies centre 4 produces television applications via an output 9 to a memory for static data 8 destined for a broadcasting generator 11 which produces, in a language tailored to the transmission channel 3 and to the stations of the customers 2, the broadcast applications.

In a first embodiment, the agencies centre 4 produces, under the control of a programmer user, at least one digital television application.

For this purpose, the agencies centre 4 mobilizes computer resources 5 as a function of target profiles 7 so as to compile projects 6. The computer resources comprise hardware elements such as disk files or network files, multimedia broadcasting facilities, etc., and software elements such as lists, screen pages, audiovisual scenes, etc. The target profiles constitute precompiled programming frameworks which the user may then reprogramme as he/she desires into at least one project, as is well known in the techniques of object programming. These various elements will be described further later on.

The digital television application produced by the centre 4 is written in a task description language such as the XML language or some other high-level computer language and is forwarded to a descriptions generator 30 one output of which is connected to the low-level language applications generator 11 intended for any user station connected to the network, directly or otherwise. During the production process relating to the digital television applications according to the invention, the codes emanating from the codes generator 12 are transmitted to the application generator 13 which may possibly receive the data from the data generator 14, and which produces by way of output a list which constitutes a picture of the tunings and start-up trials for service streams on the broadcasting network. The low-level language applications generator 11 returns a trial code to an error manager module 31 which is connected to the agencies centre 4 so as to allow tailored tuning under the control of the programmer or of a tuning handler.

In another embodiment, which will be detailed later with the aid of FIG. 6, the agencies centre 4 of the embodiment of FIG. 1 is divided over several worksets, for example linked by a local area network. Each set comprises rights of partial access to the resources of the agencies centre 4, so that a given set produces a part of a digital television programme which is transmitted to another set endowed with rights of higher access which may then transcode it so as to prepare for the broadcasting thereof.

Returning to the embodiment of FIG. 1, the broadcasting generator 11 chiefly comprises a codes generator 12, connected to an applications generator 13, which receives data from a data generator 14. The output 15 from the generator 11 can be stored in a dynamic data memory 16 which can also be read-accessed via a link-up 17, especially when one or more customer stations return data to the broadcaster 1 as is the case in an interactive television application.

The dynamic data memory 16 is connected by a bidirectional link 20 to a communications manager 19 whose output is connected to the communications channel 3.

The communications channel 3 chiefly comprises a link 21 with the communications manager 19, which is linked to a communications generator 22 which, as a function of the application installed on the customer stations 2, generates and monitors the streams between the broadcaster 1 and the various customer stations 2 by virtue of a distribution network 23 connected to a private network 24 (for example, the wiring of a building and a link 25 of the network 24 to the station 2) or directly over a distribution network 23, 25 such as the switched telephone network, a link over the airwaves, etc.

The customer station 2 chiefly comprises a digital television programmes reader 26 connected to a console 27 for reading and, possibly in an interactive television application, for inputting commands or for interventions of the user of the customer station 2; and a local memory 28 storing the programmes and the data of the television application currently being executed.

The customer station 2 is managed by so-called customer digital television platform station management software 29 which depends on the customer station 2, for example the digital television network access provider.

The communications manager 19 is furnished with software applications which allow communications of one or other of the following types:

text and according to the international protocol ftp (file transfer protocol);

database according to one or other of the standards for multimedia databases (ODBC or PRC, in particular);

web-type http protocol; or

Télétel or Minitel protocols.

The assembly consisting of the dynamic data memory 16 and the communications manager 19 is, in a preferred embodiment, associated in an electronic commerce software application 30. In such an application, especially in an interactive television network, the exchanges of data and of interactive television applications are monitored in particular so as to establish payment by each user or customer connected to the network. Such electronic commerce applications may also be utilized within the framework of the network of the invention.

The agencies centre will now be described with the aid of FIGS. 1 and 2. The agencies centre makes it possible to create, modify and broadcast any television application, interactive or otherwise. The centre 2 deals with the complete implementation process from the retrieval of the files in the memories 8 and 16 of the network, through page layout and predisplay before sending the television application over the network, and up to the recording of an optimized stream on the broadcasting server.

This collection of tasks is carried out by three agencies, all operating in the same way, each being dedicated to implementation of a complete phase of a digital television application:

1. The media agency 41 constitutes a means for editing and organizing the content. It allows the retrieval, centralization, archiving and organization of all the media intended to make up the channel or the interactive application.

2. The programmes agency 42 constitutes a means of editing and updating the programmes. It makes it possible to build an interactive application according to a tree and a navigation both of which can be defined when composing the programme or the set of interactive television programmes (CityLine®, Juke-Box TV®, OpenShop®, Finance-Line®, etc.) or any other specific interactive application, in particular when the latter requires content updates. The programmes agency also makes it possible to implement so-called “PlayList” execution lists while defining the broadcasting rules of the media thereof.

The updates are then dynamic and may be performed as often as desired.

The various programmes and programmings thus implemented may then be indexed and archived for subsequent use.

3. The sites agency 43 constitutes a means of broadcasting the programmes. It makes it possible to broadcast the programmes formulated with the programmes agency 42.

For mass public broadcasts (satellite, cable, etc.), the agency 43 comprises a means for referencing the applications generators and broadcasting servers in place, so that the generators such as the generator 11 (FIG. 1) can deposit their streams directly on the desired servers.

Within the framework of private networks, the sites agency 43 comprises a means for customizing the broadcast as a function of site typology, groups of sites, lone sites, or even of television screen, of times and days of the week.

The feedback of information making it possible, in the case of interactive television networks, to concentrate the usage statistics for the applications package systems is also managed from the sites agency 43. It is then possible to accurately ascertain the time of use per set, the dates of inquiry, the most requested information, etc. in order to best tailor its products.

All the information from the three agencies 41 to 43, managed, stored and manipulated by the agencies, can be exported in various formats (Profile, Tabulated Ascii, XML etc.), and constitutes an exact description of the desired programme.

Depending on the format thereof, this information may be read directly by navigation applications (Internet navigators known as “web browsers” or the like) or tailored systems (television managers, etc.), or else be retrieved automatically by application generators and data generators, which then produce the desired applications.

According to an important characteristic of the invention, the three agencies 41 to 43 all operate according to the same principle. To each agency there corresponds a window, and all the windows have the same presentation and operate in the same way which it is therefore easy to learn quickly, all the more so since the user interface is chosen according to the standard interfaces for computing.

The agencies 41 to 43 manipulate icons and transitory menus (of the “pop-up” type). To construct an application, it is sufficient to copy existing models, in the static data memory 8, and to tailor them to the requirements of the television application currently being produced or updated.

The icons represent conventional objects: pictures, texts, screens, etc. which are customized by parametrizing them with the aid of “pop-up” transitory menus or keypad input.

Whatever the target system, public or private television, personal computer, etc., the agencies centre 4 does not necessitate the learning of any specific language.

According to another advantageous characteristic of the invention, the agencies centre 4 makes it possible to produce applications for any type of interactive audiovisual platform. Specifically, the agencies centre 4 according to the invention translates all the information into a language which caters for the main platforms. This translation is then retrieved by the applications generator 11 which compiles it and automatically implements all the tasks required for the final production of the television application. Obviously, there are as many generators as target systems and especially three generators make it possible to produce applications for the following systems: StreamCast®, OpenTV®, MediaHighway®.

This architecture makes it possible to broaden the range of target systems by optimizing the means:

a new target system merely requires the production of a new generator;

no new interface need be relearned in order to produce an application on this new system.

According to another advantageous characteristic of the invention, the pair consisting of the agencies centre 4 and generator 11 permits delocalizing of the worksets. The various software communicate via the Internet network layer (with the aid of applications known as “sockets”) and can work remotely as if they were installed on the same set.

According to another characteristic of the invention, the agencies centre 4 comprises a means for permitting several levels of use, thus making it possible to install an update version at the final customer, so that he can himself perform his content modifications. Several levels of use defining access rights are provided, from simple inquiry, through modification of a display or the addition of a header within a screen, up to the complete creation of programmes.

According to another advantageous characteristic of the invention, the broadcaster 1 also comprises a generator of descriptions 30 of the applications currently under production from a master set and a manager of errors 31 producing reports regarding any errors.

The programmes are created in the programmes agency 42 by actions on the simple programme elements, which are similar to those performed within office tools: selection, so-called “pop-up” transitory menu, keypad input, copy/paste, etc.

Each screen making up the programme can be viewed on the production set before broadcasting.

When the programme has terminated, it is sufficient to press the “Generate” key. The programme is sent to the generator 11 which will produce an application thereof. It merely remains to test the application in a real situation.

According to another characteristic of the invention, the updating of a programme runs in almost the same way, except that the programme is already created. One merely needs to change the contents of the elements, then to display on the update set the result of the modifications made.

Once validated, the programme need merely be regenerated by pressing the “Generate” key. The programme will be sent to the generator 11 which will perform the update and will produce the new version of the programme. There is a saving system which makes it possible to store the earlier versions of the programmes, so as to be able to retrieve them and reuse them subsequently.

Any programme implemented in the programmes agency 42 can be exported so as to be reutilized by another agency.

There are two export formats, TXT and XML, which allow any other piece of software able to analyse and import these formats to retrieve the entire programme as it was defined in the programmes agency.

This export format can also be used to perform saves of these programmes.

Represented in FIG. 3 is the common architecture of the three agencies 41 to 43 making up the agencies centre 4 (FIG. 1) according to the preferred embodiment of the invention. Each agency 41 to 43 is callable by an agencies manager 40 which will be described later.

Each agency comprises software which is executed in a window on one or more computers or the like. The windows of the agencies are all organized in the same way and each agency window comprises four main zones described in FIG. 3: a menu bar 45, a hierarchical list zone 46, a contents display zone 47 and a properties zone 48.

The menu bar 45 groups together all the functions applicable in the current agency. These functions are similar to the conventional office software. The function applies always to the element, or to the group of elements, currently undergoing selection in the agency. The selections are performed in two ways, with the hierarchical list or from the Display table.

The drop-down menu also appears by clicking with the right button on an element from the hierarchical list or from the display table. This system allows direct specification of the element relevant to the function which will be chosen from the menu.

The hierarchical list 46 makes it possible to organize and select the elements. Depending on the current agency, it makes it possible for the elements manipulated by the agency (media, programmes and broadcasting sites) to be arranged arbitrarily.

The hierarchical list 46 is synchronized with the other zones of the agency window 44. When an element is selected, the content display zone 48 and properties zone 47 automatically update themselves so as to display the information relating to the selected element.

The content display zone 48 offers the possibility of several ways of consulting the content relating to the element selected from the hierarchical list. One switches from one mode to the other by clicking on the corresponding tab. Refer also to FIG. 5.

The Table mode 55 makes it possible to consult the list of elements making up the element selected from the hierarchical list 46. This mode is available only for elements which can contain others: folders, programmes, scenes, pages, etc. The table generally comprises several columns. By default, the table is always sorted in alphabetical order of the “Name” column, but it is possible to modify the sort order by clicking on the title of the column of one's choice. With each click, the table is sorted alternately in alphabetical order and in reverse alphabetical order.

The Zoom mode 56 is reserved for the case of media and of basic elements (pictures, texts, etc.), the display zone 48 displays the content, that is to say the associated physical file, directly.

The Caption mode 57 is an intermediate mode between the Zoom and Table modes. The collection of elements making up the selected element is displayed in the form of an array, the elements having associated physical files being displayed directly in reduced form.

The Selection mode 58, just as with the hierarchical list 46, renders the contents display zone 48 interactive and makes it possible to select elements. The properties zone 47 is then synchronized with the selected element: the synchronization also operates in the other two modes: caption and zoom. The various ways of selecting an element are:

in Table mode: click on a row;

in Caption mode: click on a box of the array;

in Zoom mode: the element displayed is automatically selected. A change of element and hence a change of selection is effected by scrolling the elements with the vertical scrolibar.

Certain accelerators make it possible to switch directly into Zoom mode:

in Table mode: double click on an element;

in Caption mode: click on a selected element, or double click on an unselected element.

It is also possible to backtrack one level in the hierarchical list by clicking on the “backtrack” icon in the top right of the display zone.

Unlike the hierarchical list, the display table comprises a means for selecting several elements by clicking successively on the elements whilst pressing the “CTRL” or “SHIFT” keys. The “CTRL” key selects the elements one by one whilst the SHIFT key selects all the elements included between the previous click and the click associated with the “SHIFT” key. In this case, the properties are resynchronized with the element selected from the hierarchical list.

The properties zone 47 is reproduced in FIG. 4 and displays the collection of information relating to the selected element:

type of the selected element 51 in a type zone for example by tabs or by icons;

name of the selected element 52 in an alphanumeric zone;

properties of the selected element 53 in various conventional computer objects such as list zones, buttons, group zones, etc.

These properties are individual to each type of element and depend on the current agency. The details of the properties of each type of element are described in each of the agencies.

On the other hand, the properties zone operates in the same way for all the elements. Most of the values displayed can be modified with the aid of “pop-up” transitory menus or of keypad input zones.

All the modifications are automatically taken into account and stored. It is never necessary to record one's modifications.

Certain values relating to display, such as colours, font, etc., are automatically carried over into the display zone when the Zoom mode is activated.

The three agencies of the agencies centre will now be described briefly, these being:

the media agency;

the programmes agency;

the sites agency;

which are called from an agencies manager (40 in FIG. 2).

The agencies manager (40 in FIG. 2) is the main window for calling the aforesaid agencies. It is essentially implemented as a toolbar which is always available and makes it possible to call the desired agency. The toolbar therefore contains three buttons each reserved for one of the three agencies (41-43). However, the agencies manager is connected to an access rights manager which limits access of the agencies centre to the resources and target profiles depending on the set where it is installed.

The media agency is an agency specialized in organizing and managing the media, that is to say the physical files—the contents—of the programmes.

The media agency makes it possible to reorganize and rename the media in such a way, doing so without ever changing anything with regard to the resources (hard disk, memories, networks), as to create its own folders, give more sensible names to the contents, organize the contents by programme, by version, by screen, by type of medium without any risk of modifying the physical supports in any way.

The programmes agency 42 is a means of creating and updating audiovisual programmes, interactive or otherwise. It organizes the programmes which are predisplayable on the agency 42 such as they will be displayed on a customer station 2.

All the creation functions, modifications are available: create, change, duplicate, delete screens, modify, add, delete contents, position, parametrize the contents in the screens, display all or part of a screen as on a television set. The programmes thus implemented are in their turn available to generate a complete televisual application, to generate an update of the programme, or to serve as basis for a new application.

The main elements of the three agencies will now be described in detail whilst referring to the comparable elements already mentioned.

III. Media Agency

The media agency is specialized in the management of contents, that is to say the physical files of pictures, texts, videos and sounds. The media agency comprises a means for displaying in the screens of the programmes elements originating from a medium:

a picture on the screen will be displayed via an element of picture type filled in by a medium of picture type;

a text on the screen will be displayed via an element of text type filled in by a medium of text type, etc.

The media agency provides the subject matter, whilst the programmes agency manages their formatting:

a medium of picture type provides the photo of a product whilst the picture element indicates the position of the picture (the photo of the product), for example in the form screen produced;

a medium of text type provides the attention-grabber “Issue of the month!”, whilst the element of text type indicates the position of this text on the screen, the character font to be used, the colour, etc.

This principle of segregation between content and formatting is important since it is the basis of numerous functionalities.

The updates may be performed simply by changing content without jeopardizing the presentation of the programmes.

One and the same medium can be used in several different screens, its modification bringing about the automatic updating of all the screens at the same time. For example: the price of a product is present in three screens: the product list, the product form and the purchase note. The principle of segregation makes it possible to update the price on all the screens in one go.

The media agency therefore acts as a catalogue or a customizable multimedia database:

The media are catalogued, organized, sortable and reusable;

Each medium can be used at several different locations;

The indexing and naming are unrestricted.

The media agency adopts the colour code, for example, blue, which renders it easily recognizable from among the three agencies of the centre, borrows all the characteristics of a general agency window and adds the objects and functions required for the specific management of the media which are:

the ASSOCIATE function: for filling in an element of another agency with the content of the medium;

the EDIT function: for modifying the content of the medium;

the REPLACE function: for changing the physical file of the medium.

The menu bar comprises the commands which deploy the means for performing and executing the following functions:

| Function | Description |
|---|---|
| Display | Displays the selected medium. |
| New | Displays the submenu for creating media. |
| New/Folder | Opens the input window for creating a folder at |
| | the level of the selected element. |
| New/Medium | Opens the input window for creating a medium at |
| | the level of the selected element. |
| Rename/ | Opens the input window for renaming or [F2] |
| Modify | changing the type of element selected. |
| Delete | Deletes the selected element or elements. |
| Copy | Stores the selected element or elements in |
| | memory with a view to executing the following |
| | functions. |
| Duplicate | Duplicates the medium or media copied at the |
| | level of the element selected (the duplicated |
| | media will share the same physical files as the |
| | source media (files will not be duplicated on the |
| | physical supports)). |
| Move | Moves the medium or media copied at the level |
| | of the selected element. |
| Export | Exports the description of the selected element |
| | → a file <name_element>.txt is generated in the |
| | ROLexp directory of the agency. |
| Import | Imports the description of an element from an |
| | export file (export from a third-party application). |
| Add | Displays the submenu for adding a medium from |
| | a physical file. |
| Add/Video | Opens the video selection window to add a |
| | medium at the level of the selected element → |
| | the recognized physical files have the |
| | extensions: AVI, MPG, MOV. |
| Add/Picture | Opens the picture selection window to add a |
| | medium at the level of the selected element → |
| | the recognized physical files have the |
| | extensions: BMP, JPG, GIF, TIF, PIC. |
| Add/Audio | Opens the selection window for adding an audio |
| | medium at the level of the selected element → |
| | the recognized physical files have the |
| | extensions: WAV, RM, MOV. |
| Add/Text | Opens the text selection window for adding a |
| | medium at the level of the selected element → |
| | the recognized physical files have the |
| | extensions: TXT, INI. |
| Add/File | Opens the multifile selection window for adding |
| | any medium at the level of the selected element |
| | → the recognized physical files have the same |
| | extensions as those mentioned above. |
| Replace | Opens the selection window corresponding to the |
| | type of medium selected so as to replace its |
| | physical file → the elements of the other |
| | agencies associated with this medium will have |
| | the new selected physical file as content. |

The hierarchical list remains similar to the hierarchical lists of the other agencies.

The Display zone carries the various aforesaid modes. In the Table mode, the list of media contained in the folder selected from the hierarchical list is displayed. The five columns of the table displayed in Table mode correspond to the following information:

| | |
|---|---|
| Name | Name of the medium in the agency (file name). |
| Type | Type of the medium (text, picture, sound, etc.). |
| File | Name of the physical file constituting the content of |
| | the medium. |
| Extract | Reserved for future use. |
| Folder | Complete path of the folder containing the physical |
| | file. |

The Zoom mode displays the content of the physical file referenced by the medium selected from the hierarchical list.

This mode makes it possible to access two particular functions individual to this agency:

| Function | Description |
|---|---|
| Edit the | Initiates the Windows © application associated with |
| content | the physical file type referenced by the current |
| | element. For example, Paint © for a dot- type file |
| | (“bitmap”*.BMP), etc. → as long as the application |
| | initiated is active, the agency is disabled. |
| Replace | Opens the selection window corresponding to the |
| the file | physical file type associated with the current |
| | element Cf. the selection windows. |

In Caption mode the list of media contained in the folder selected from the hierarchical list is presented in array form.

In the Properties zone 48 associated with the media agency 41, the media agency comprises means for producing seven types of medium, namely:

1. folder

2. video

3. picture

4. sound

5. text

6. HTML

7. Database

Each type of medium is defined by properties selected by the programmer on the media agency namely:

| for the “folder” type: | |
|---|---|
| Description | serves to group together and to organize the |
| | media. |
| Hierarchy | Node element which can contain any medium in |
| | the agency of media including the folders. |
| Link-up | Video element of the programmes agency. |
| for the video type: | |
| Description | References a video physical file |
| Hierarchy | Terminal element, cannot contain any other |
| | element |
| Link-up | Video-element of the programmes agency |
| Function | Description |
| Associate | Associates the current video-medium with the |
| | video-element selected from the programmes |
| | agency |

| Property | Type | Description | Possible values |
|---|---|---|---|
| File | Text 256 | Complete path of the | <reader>:\<folder |
| | car. max. | physical file | >\. .\<file> |
| Extract | Text 12 | Reserved for future | |
| | car. max. | use of access to a | |
| | | Database | |

| for the “picture” type: | |
|---|---|
| Description | References a picture physical file |
| Hierarchy | Terminal element, can contain no other element |
| Link-up | Picture-element of the programmes agency |
| Function | Description |
| Associate | Associates the current picture-medium with the |
| | picture-element selected from the programmes |
| | agency |

The properties of the “picture” type are identical to those of the previous medium type.

| for the “sound” type: | |
|---|---|
| Description | References an audio physical file |
| Hierarchy | Terminal element, can contain no other element |
| Link-up | Audio-element of the programmes agency |
| Function | Description |
| Associate | Associates the current audio-medium with the |
| | audio-element selected from the programmes |
| | agency |

The properties of the “sound” type are identical to those of the previous medium type.

| for the “text” type: | |
|---|---|
| Description | References a text physical file |
| Hierarchy | Terminal element, can contain no other element |
| Link-up | Text-element of the programmes agency |
| Function | Description |
| Associate | Associates the current text-medium with the text- |
| | element selected from the programmes agency |

The properties of the “text” type are identical to those of the previous medium type.

| For the “html” type: | |
|---|---|
| Description | References an html physical file for Internet |
| | connection |
| for the “database” type: | |
| Description | References a database |

IV. Programmes Agency

The programmes agency is specialized in the creation and updating of programmes. These programmes are typical applications, composed of elements which can be devised individually in one's way, provided that the envisaged behaviour is complied with: ordered lists “playlist”, catalogues, training, etc. A programme generally consists of the following elements:

Scenes, which correspond to the logic screens of the application, for example: the resume, the purchase note, the MCQ (“multiple choice questionnaire”).

Generic elements, which are common to several screen scenes—and are used by the application when it needs them, for example: an “Exit” or OK” button, etc.

The scenes are in turn composed of programme elements which manage the formatting and behaviour of the screens of the application:

a picture element specifies the position of a picture medium on the screen;

a text element specifies the position of a text medium on the screen, as well as the character font and the colour to be used, etc.

Other more complex programme elements make it possible to manage off-the-shelf functionalities:

A list element automatically manages a list of choices on the screen;

The page elements make it possible to chop a screen into several pages displayed on the same background;

The routing element makes it possible to indicate the navigation to another screen, possibly according to certain conditions, etc.

The instruction element makes it possible to insert automatic function modules, such as for example connection for sending a command, or the input of a bank card, etc.

Once these programmes have been customized, the programmes agency makes it possible to:

display the screens one by one in all possible states: selection of headings of a menu, scrolling of pages, etc.

generate the source code and send it to the generator corresponding to the application type chosen.

This principle of operation is important since it permits the following possibilities:

Display the application under the conditions, without necessarily possessing the specific development environment: decoder, television set, etc.

Tune applications independently of the intended target system

Reuse these programmes to implement updates or similar programmes, but with other contents.

The programmes agency therefore acts as a multiplatform application editor:

Drafting the layout of programmes before implementation;

Tuning of programmes and generation of applications;

Updating of content;

Reuse of all or part of an existing programme in the agency.

The programmes agency adopts the colour code, for example yellow, which renders it easily recognizable from among the three agencies of the centre, borrows all the characteristics of a general agency window and adds the objects and functions required for the specific management of the programmes:

The GENERATE function for initiating the generation of the source code and sending it to the generator;

The DISPLAY function for displaying the scene such as on a TV screen;

The MEDIA AGENCY function for opening the media agency while automatically pointing to the medium associated with the current element;

The CHANGE MEDIUM function for selecting another medium of the media agency and associating it with the current element;

The EDIT CONTENT function for creating or modifying the content of the associated medium and hence of the current element;

The EMPTY CONTENT function for breaking the link-up between associated medium and the current element.

The menu bar comprises the commands which deploy the means for performing and executing the following functions:

| Menu option | Function |
|---|---|
| Display | Displays the element selected such as on a TV |
| | screen. |
| New | Displays the submenu for creating programme |
| | elements. |
| New/ | Opens the input window for creating a folder at the |
| Folder | level of the selected element. |
| New/ | Opens the input window for creating a programme |
| Element | element at the level of the selected element. |
| New/ | Opens the input window for creating a programme |
| Program | at the level of the selected element. This function |
| | is available only in author mode. |
| Rename/ | Opens the input window for renaming or changing |
| Modify | the type of element selected. |
| Delete | Deletes the selected element or elements. |
| Delete the | Deletes the link-up - the association - medium with |
| link-ups | the selected element or elements → the |
| | programme elements retain their properties but no |
| | longer have content. |
| Copy | Stores the selected element or elements with a |
| | view to executing the following functions. |
| Paste | Duplicated in the media link-ups, the element or |
| | elements copied, at the level of the selected |
| | element → the duplicated elements have the same |
| | properties as the source elements, but are empty |
| | (no content). |
| Duplicate | Duplicated with the media link-ups, the element or |
| | elements copied, at the level of the selected |
| | element → the duplicated elements will share the |
| | same media - and therefore the same contents - as |
| | the source elements (the media will not be |
| | duplicated in the media agency). |
| Move | Moves the copied element or elements at the level |
| | of the selected element. |
| Export | Exports the description of the selected element → |
| | a file <name_element>.txt is generated in the |
| | ROLexp directory of the agency → execute from a |
| | programme, this function allows saving as well as |
| | the transfer of a programme from one agency to |
| | the other. |
| Import | Imports the description of an element from an |
| | export file → execute from a programme file, this |
| | function allows recovery thereof as well as the |
| | retrieval of a programme from another agency. |
| Medium | Opens the selection window of a medium in order |
| | to associate it with the current element. |
| Content | Opens the selection window corresponding to the |
| | type of element selected so as to define or edit its |
| | content. |

The hierarchical list of the programmes agency exhibits the same characteristics as those common to the agencies.

The Table mode displays the list of programmes or of programme elements contained in the folder, the programme or the element selected from the hierarchical list.

The columns correspond to the following information:

| | |
|---|---|
| Name | Name of the element in the agency. |
| Type | Type of the element. |
| Associated | Name of the medium associated with the element. |
| medium | |

Reminder: it is the medium which provides the element with the content. The element manages only the formatting parameters.

The Zoom mode displays the content of the medium associated with the element selected from the hierarchical list.

The Zoom mode is available only for elements which can be associated with a content and makes it possible to access four particular functions individual to this agency:

| Function | Description |
|---|---|
| Media | Calls the media agency while positioning itself on |
| agency | the medium associated with the current element. |
| Change | Opens the selection window so as to associate a |
| medium | corresponding medium with the type of the |
| | current element. Cf. the selection windows. |
| Associate a | When the element is empty, that is to say when |
| medium | no medium is associated, this button is called |
| | “Associate a medium”. |
| Edit the | Initiates the Windows ® application associated |
| content | with the physical file type referenced the medium |
| | associated with the current element. |
| Define the | For example, Paint ® for a BMP file → as long as |
| content | the application initiated is active, the agency is |
| | disabled. When the element is empty, that is to |
| | say when no medium is associated, this button is |
| | called “Define the content”. In this case, the |
| | function opens the selection window |
| | corresponding to the physical file type associable |
| | with the current element. By clicking on validate, |
| | the medium is automatically created in the media |
| | agency, before being automatically associated |
| | with the current element. Cf. the selection |
| | windows. |
| Empty any | Breaks the link-up - association - between the |
| content | current element and the associated medium. → |
| | The current element retains its formatting |
| | properties but no longer has any content. From |
| | this mode, there are two ways of reassociating |
| | the content with the current element: |
| | 1) via the “Associate a medium” function by |
| | selecting a content already present in the media |
| | agency. |
| | 2) via the “Define a content” function by directly |
| | selecting a physical file on the hard disk. In this |
| | case, the corresponding medium is automatically |
| | created in the media agency before being |
| | associated with the current element. |

The Caption mode presents in the form of an array the list of elements contained in the folder, the programme or the element currently being selected from the hierarchical list. Depending on the type of element, the caption displays the content or a message when a terminal element is involved, or the icon of its type when a node element is involved. In this case, the selecting of the icon amounts to “descending” through the hierarchy and is equivalent to selecting the element from the hierarchical list. The Caption mode then displays the elements contained in the selected node element. The selecting of a “Backtrack” icon situated on the right of the display zone makes it possible to go back through the hierarchy.

Generally the agencies centre 4 manages just one type of programme. Only a special mode opened by access to a higher access right makes it possible to manipulate several types of programme. The various types of programmes managed by the agencies centre are picked from among the following collection: {folder, execution list, synchronized execution list, Interactive directory, catalogue, Module for executing programme lists, Advertisement insertion module, Training module, Module for managing stock market programmes} whose defining elements are given hereinbelow.

| “folder”: | |
|---|---|
| Description | Serves to group together and to organize. |
| Hierarchy | Any element or programme of the programmes |
| | agency, including folders. |
| Link-up | No |
| “PLAYLIST” “execution list” | |
| Description | Management of noninteractive televisual |
| | programmes. |
| Hierarchy | Any noninteractive element of the programmes |
| | agency. |
| Link-up | Any site of the sites agency. |
| Function | Description |
| Generate | Initiates the generation of the source code → |
| | depending on the type of use, the code is |
| | generated in the native format (CityLine, Juke- |
| | Box, etc.) or sent to the generator. |
| Log file | No |
| Broadcast | Associates the programme with the site currently |
| | selected from the sites agency. |

| Property | Type | Description | Possible values |
|---|---|---|---|
| System | Menu | Target system | StreamCast ® I |
| Network | Menu | No | |
| Mode | Menu | No | |
| Palette | Menu | No | |
| Width | Num. | Max. width | 0 to max. width of the |
| | | | screen on the TV screen |
| | | | (384 pixels on |
| | | | StreamCast ® I) |
| Height | Num. | Max. height | 0 to max. height of the |
| | | | screen on the TV screen |
| | | | (288 pixels on |
| | | | StreamCast ® I) |

System properties

| Property | Type | Description | Possible values |
|---|---|---|---|
| Channel | Num. | Stream No. in the | 1 to 255 |
| No. | | SreamCast ® programme | |
| Path No. | Num. | Path No. in the StreamCast ® | 1 to 255 |
| | channel | | |
| Priority | Num. | Priority value for the | 1 to 255 |
| | | automatic regulation of | |
| | | broadcasting of StreamCast | |
| | | pathways | |

| “TIMED PLAYLIST” “synchronized execution list” | |
|---|---|
| Description | Management of noninteractive televisual |
| | programmes with broadcasting grid. |
| Hierarchy | Any element of the programmes agency. |
| Link-up | Any site of the sites agency. |
| Function | Description |
| Generate | Initiates the generation of the source code → |
| | depending on the type of use, the code is |
| | generated in the native format (CityLine ®, Juke- |
| | Box, etc.) or sent to the generator. |
| Log file | No |
| Broadcast | Associates the programme with the site currently |
| | selected from the sites agency. |

| Property | Type | Description | Possible values |
|---|---|---|---|
| System | Menu | Target system | StreamCast ® I |
| Network | Menu | No | |
| Mode | Menu | No | |
| Palette | Menu | No | |
| Width | Num. | Max. width on | 0 to max. width of the |
| | | the TV screen | screen (384 pixels on |
| | | | StreamCast ® I) |
| Height | Num. | Max. height on | 0 to max. height of the |
| | | the TV screen | screen (288 pixels on |
| | | | StreamCast ® I) |

System properties

| Property | Type | Description | Possible values |
|---|---|---|---|
| Channel | Num. | Stream No. in the | 1 to 255 |
| No. | | StreamCast ® programme | |
| Path No. | Num. | Path No. in the StreamCast ® | 1 to 255 |
| | | channel | |
| Priority | Num. | Priority value for the | 1 to 255 |
| | | automatic regulation of | |
| | | broadcasting of StreamCast ® | |
| | | pathways | |

| “CITYLINE” “interactive directory” | |
|---|---|
| Description | Management of interactive televisual programmes |
| | of directory type regarding leisure and tourism. |
| Hierarchy | Any element of the programmes agency. |
| Link-up | Any site of the sites agency. |
| Function | Description |
| Generate | Initiates the generation of the source code → the |
| | code is generated in the native format and |
| | requires no sending to a generator. |
| Log file | No |
| Broadcast | Associates the programme with the site currently |
| | selected from the sites agency. |

| Property | Type | Description | Possible values |
|---|---|---|---|
| System | Menu | Target system | StreamCast ® I |
| Network | Menu | No | |
| Mode | Menu | No | |
| Palette | Menu | No | |
| Width | Num. | Max. width on | 0 to max. width of the |
| | | the TV screen | screen (384 pixels on |
| | | | StreamCast ® I) |
| Height | Num. | Max. height on | 0 to max. height of the |
| | | the TV screen | screen (288 pixels on |
| | | | StreamCast ® I) |

| “catalogue”: | |
|---|---|
| Description | Management of interactive televisual programmes |
| | of E-commerce type (electronic commerce: - |
| | OpenShop ® = Catalogue on TPS ®. |
| Hierarchy | Any element from the programmes agency, |
| | except: the folders and the programmes. |
| Link-up | Any site of the sites agency. |
| Function | Description |
| Generate | Initiates the generation of the source code, then |
| | sends it to the generator. |
| Log file | Report file returned by the generator. |
| Broadcast | Associates the programme with the site currently |
| | selected from the sites agency. |

| Property | Type | Description | Possible values |
|---|---|---|---|
| System | Menu | Target system | OpenTV ® Standard = |
| | | | broadcasting |
| | | | OpenTV SDK = tuning |
| Network | Menu | Broadcasting | OnAir ® network = |
| | | network | broadcasting |
| | | | Internal Network = tuning |
| Mode | Menu | Execution | Release = broadcasting of |
| | | mode | programme Debug = tuning |
| Palette | Menu | Palette of 16 | The palette button makes it |
| | | colours of the | possible to create/ |
| | | OSDs | modify/edit the palettes. Cf. |
| | | | palette selection window. |
| | | | The palettes supervised |
| | | | are *.TXT files stored in the |
| | | | ROLclut folder |
| Width | Num. | Max. width on | 0 to max. width of the |
| | | the TV screen | screen (720 pixels on |
| | | | OpenTV ®) |
| Height | Num. | Max. height on | 0 to max. height of the |
| | | the TV screen | screen (576 pixels on |
| | | | OpenTV ®) |

System properties

| Property | Type | Description | Possible values |
|---|---|---|---|
| Stream | Num. | Stream identification No. | 1 to 10. |
| No. | | | |
| Bit rate | Num. | Bit rate in bit/sec of the | Generally, from |
| | | stream during its | 150,000 to |
| | | broadcasting. | 800,000 b/s. |
| AddressIP | Text | IP address of the | xxx.xxx.xxx.xxx |
| | | generator where the | |
| | | generated source code | |
| | | is sent (cf. TCP/IP | |
| | | protocol standard). | |

| “module for executing the programmes lists” (JUKE-BOX): | |
|---|---|
| Description | Management of televisual programmes of juke- |
| | box type, permitting playlist, timed-playlist and |
| | selection by the user of a clip or playlist. |
| Hierarchy | Any element from the programmes agency. |
| Link-up | Any site from the sites agency. |
| Function | Description |
| Generate | Initiates the generation of the source code → the |
| | code is generated in the native format and does |
| | not require any sending to a generator. |
| Log file | No |
| Broadcast | Associates the programme with the site currently |
| | selected from the sites agency. |

| Property | Type | Description | Possible values |
|---|---|---|---|
| System | Menu | Target system | StreamCast I ® |
| Network | Menu | No | |
| Mode | Menu | No | |
| Palette | Menu | No | |
| Width | Num. | Max. width on | 0 to max. width of the |
| | | the TV screen | screen (384 pixels on |
| | | | StreamCast I ®) |
| Height | Num. | Max. height on | 0 to max. height of the |
| | | the TV screen | screen (288 pixels on |
| | | | StreamCast I ®) |

| “Advertisement insertion module” (ADS-INSERT) | |
|---|---|
| Description | Management of televisual programmes for |
| | substitution on the advertisement spaces of |
| | theme channels transmitted over the network: - |
| | Financial Line ® = Ads-Insert with the |
| | Bloomberg ® channel. |
| Hierarchy | Any element from the programmes agency. |
| Link-up | Any site from the sites agency. |
| Function | Description |
| Generate | Initiates the generation of the source code → the |
| | code is generated in the native format and |
| | requires no sending to a generator. |
| Log file | No |
| Broadcast | Associates the programme with the site currently |
| | selected from the sites agency. |

| Property | Type | Description | Possible values |
|---|---|---|---|
| System | Menu | Target system | StreamCast I ® |
| Network | Menu | No | |
| Mode | Menu | No | |
| Palette | Menu | No | |
| Width | Num. | Max. width on | 0 to max. width of the |
| | | the TV screen | screen (384 pixels on |
| | | | StreamCast I ®) |
| Height | Num. | Max. height on | 0 to max. height of the |
| | | the TV screen | screen (288 pixels on |
| | | | StreamCast I ®) |

| “Module for managing the stock market programmes” (INFO- | |
|---|---|
| STOCK) | |
| Description | Management of interactive televisual programmes |
| | of stock market information type transmitted by a |
| | producer over the network. |
| Hierarchy | Any element from the programmes agency. |
| Link-up | Any site from the sites agency. |
| Function | Description |
| Generate | Initiates the generation of the source code → the |
| | code is generated in the XML format and requires |
| | no sending to the generator which itself detects |
| | the arrival of new files. |
| Log file | No |
| Broadcast | Associates the programme with the site currently |
| | selected from the sites agency. |

| Property | Type | Description | Possible values |
|---|---|---|---|
| System | Menu | Target system | MediaHighway |
| | | | (example) |
| Network | Menu | Network of OnAir | |
| | | Networks = | |
| | | broadcasting | |
| | | Internal Network | |
| | | broadcasting = | |
| | | tuning | |
| Mode | Menu | Mode of execution | |
| | | Release = | |
| | | broadcasting of | |
| | | the programme | |
| | | Debug = tuning | |
| Palette | Menu | Palette of 16 | The palette button |
| | | colours of the | makes it possible to |
| | | OSDs | create/modify/edit the |
| | | | palettes. Cf. Palette |
| | | | selection window. The |
| | | | palettes supervised are |
| | | | *.TXT files stored in the |
| | | | ROLclut folder. |
| Width | Num. | Max. width on the | 0 to max. width of the |
| | | TV screen | screen (720 pixels on |
| | | | MediaHighway ®). |
| Height | Num. | Max. height on the | 0 to max. height of the |
| | | TV screen | screen (576 pixels on |
| | | | MediaHighway ®). |

The types of elements are specialized objects of the programmes agency making it possible to describe the programmes. These elements descriptive of the programmes are picked from the following collection: {structure, video, sound, picture, text, design, page, list, slide show, scene, routing, instruction} whose defining elements are given hereinopposite.

| “STRUCTURE” | |
|---|---|
| Description | Serves to group together and to organize Note: |
| | unlike folders, the grouping together into a |
| | structure has a significance on the programme |
| | generated. The rules for grouping together into |
| | a structure are individual to each generator. |
| Hierarchy | Any element of the programmes agency, |
| | including structures. |
| Link-up | No |
| Property | No |
| “VIDEO” | |
| Description | Describes the characteristics of presentation of |
| | a video element in a programme.0 |
| Hierarchy | No |
| Link-up | A video medium of the media agency |

| Property | Type | Description | Possible values |
|---|---|---|---|
| Width | Num. | Width of the element | 0 = adjusts the size to |
| | | on the screen | the content |
| Height | Num. | Height of the | 0 = adjusts the size to |
| | | element on the | the content |
| | | screen | |
| Coord. X | Num. | Left coordinate of | 0 to max. width |
| | | the element on the | |
| | | screen. of the | |
| | | screen | |
| Coord. Y | Num. | Top coordinate of | 0 to max. height of the |
| | | the element on the | screen. |
| | | screen | |
| Duration | Num. | Duration of display | - Expressed in |
| | | of the element on | HH:MM:SS:CC (2 min. |
| | | the screen | 50 sec. = |
| | | | 00:02:50:00) − 0 = |
| | | | adjusts the duration to |
| | | | the content |

| “SOUND” | |
|---|---|
| Description | Describes the characteristics of presentation of |
| | an audio element in a programme |
| Hierarchy | No |
| Link-up | An audio medium of the media agency |

| Property | Type | Description | Possible values |
|---|---|---|---|
| Duration | Num. | Duration of display | Expressed in |
| | | of the element on | HH:MM:SS:CC (2 min. |
| | | the screen | 50 sec. = 00:02:50:00) − |
| | | | 0 = adjusts the |
| | | | duration to the content |

| “PICTURE” | |
|---|---|
| Description | Describes the characteristics of presentation of |
| | a picture element in a programme |
| Hierarchy | No |
| Link-up | A picture medium of the media agency |

| Property | Type | Description | Possible values |
|---|---|---|---|
| Usage | Menu | Determines the | List of values of the |
| | | particular usage for | T_FUNCT table. |
| | | which the element is | |
| | | intended | |
| Width | Num. | Width of the element | 0 = adjusts the size |
| | | on the screen | to the content. |
| Height | Num. | Height of the element | 0 = adjusts the size |
| | | on the screen | to the content. |
| Format | Menu | Format of the picture | List of values of the |
| | | on the target system | T_PICTURE table. |
| Weight | Num. | Max. size of the file | Weight in bytes. |
| | | in the target format | |
| Quality | Num. | Quality of | Quality in % of |
| | | compression | compression |
| | | | (cf. generators doc). |
| Coord. X | Num. | Left coordinate of the | 0 to max. width of the |
| | | element on the | screen. |
| | | screen | |
| Coord. Y | Num. | Top coordinate of the | 0 to max. height of |
| | | element on the | the screen. |
| | | screen | |
| Duration | Num. | Duration of display of | Expressed in |
| | | the element on the | HH:MM:SS:CC (2 |
| | | screen | min. 50 sec. = |
| | | | 00:02:50:00) − 0 = |
| | | | permanent display. |

(1) Appearance properties

| Property | Type | Description | Possible values |
|---|---|---|---|
| X | Num. | Ditto Coord. X for the | 0 = no effect |
| | | point of appearance | |
| | | of the element | |
| Y | Num. | Ditto Coord. Y for the | 0 = no effect |
| | | point of appearance | |
| | | of the element | |
| Pulse | Num. | Instant (or time | Expressed in |
| | | code) of appearance | HH:MM:SS:CC (2 min. |
| | | of the element on the | 50 sec. = 00:02:50:00) − |
| | | screen | 0 = no effect |

| “TEXT” | |
|---|---|
| Description | Describes the characteristics of presentation of |
| | a text element in a programme. |
| Hierarchy | No |
| Link-up | A text element of the programmes agency. |

| Property | Type | Description | Possible values |
|---|---|---|---|
| Usage | Menu | Determines the | List of values of the |
| | | particular usage for | T_FUNCT table. |
| | | which the element | |
| | | is intended | |
| Width | Num. | Width of the | 0 = adjusts the size to |
| | | element on the | the content. |
| | | screen | |
| Height | Num. | Height of the | 0 = adjusts the size to |
| | | element on the | the content. |
| | | screen | |
| Palette | Text | Recalls the current | The palette button |
| | | palette, identical | makes it possible to |
| | | for the programme | modify the colours. cf. |
| | | | palette selection |
| | | | window. |
| Colour | Menu | Colour of the text | Colour in the current |
| | | on the screen | palette (No. ranging |
| | | | from 0 to 15). |
| Col. Bis | Menu | 2nd colour used | Colour in the current |
| | | depending on the | palette (No. ranging |
| | | generator: | from 0 to 15). |
| | | selection, | |
| | | background | |
| Font | Menu | Character font | List of fonts available |
| | | | in the ROLexp folder. |
| Anchoring | Menu | Position of the text | All the combinations |
| | | with respect to the | from: Horizontal: left, |
| | | anchoring point: | centre, right - |
| | | Coord.X/Coord.Y | Vertical: top, centre, |
| | | | bottom |
| | | | Line: up, down. |
| Line gap | Num. | Height of a line (in | 0 to max. height of |
| | | pixels) | the screen − |
| | | | 0 = default line gap. |
| Coord. X | Num. | Left coordinate of | 0 to max. width of the |
| | | the element on the | screen. |
| | | screen | |
| Coord. Y | Num. | Top coordinate of | 0 to max. height of |
| | | the element on the | the screen. |
| | | screen | |
| Duration | Num. | Duration of display | Expressed in |
| | | of the element on | HH:MM:SS:CC (2 min. |
| | | the screen | 50 sec. = |
| | | | 00:02:50:00) − 0 = |
| | | | permanent display. |

Appearance properties

| Property | Type | Description | Possible values |
|---|---|---|---|
| X | Num. | Ditto Coord. X for | (cf. Anchoring, on the |
| | | the point of | left by default) − |
| | | appearance of the | 0 = no effect. |
| | | element | |
| Y | Num. | Ditto Coord. Y for | (cf./Anchoring at the |
| | | the point of | top by default) − |
| | | appearance of the | 0 = no effect. |
| | | element | |
| Pulse | Num. | Instant (or time | Expressed in |
| | | code) of appearance | HH:MM:SS:CC (2 min. |
| | | of the element on | 50 sec. = |
| | | the screen | 00:02:50:00) − 0 = no |
| | | | effect. |

| “DESIGN” | |
|---|---|
| Description | Describes the characteristics of presentation of |
| | a design element in a programme |
| Hierarchy | No |
| Link-up | No |

| Property | Type | Description | Possible values |
|---|---|---|---|
| Usage | Menu | Determines the | List of values of the |
| | | particular usage | T_FUNCT table. |
| | | for which the | |
| | | element is | |
| | | intended | |
| Width | Num. | Width of the | 0 = invisible. |
| | | element on the | |
| | | screen | |
| Height | Num. | Height of the | 0 = invisible. |
| | | element on the | |
| | | screen | |
| Palette | Text | Recalls the | The palette button |
| | | current palette, | makes it possible to |
| | | identical for the | modify the colours. |
| | | programme | cf. palette selection |
| | | | window. |
| Line style | Menu | Colour of the edge | Colour in the current |
| | | | palette (No. ranging |
| | | | from 0 to 15). |
| Background | Menu | Fill-in colour | Colour in the current |
| | | | palette (No. ranging |
| | | | from 0 to 15). |
| Coord. X | Num. | Left coordinate of | 0 to max. width of |
| | | the element on | the screen. |
| | | the screen | |
| Coord. Y | Num. | Top coordinate of | 0 to max. height of |
| | | the element on | the screen. |
| | | the screen | |
| Duration | Num. | Duration of | Expressed in |
| | | display of the | HH:MM:SS:CC |
| | | element on the | (2 min. 50 sec. = |
| | | screen | 00:02:50:00) − 0 = |
| | | | permanent display. |

Appearance properties

| Property | Type | Description | Possible values |
|---|---|---|---|
| X | Num. | Ditto Coord. X for | 0 = no effect |
| | | the point of | |
| | | appearance of the | |
| | | element | |
| Y | Num. | Ditto Coord. Y | for 0 = no effect |
| | | the point of | |
| | | appearance of the | |
| | | element | |
| Pulse | Num. | Instant (or time | Expressed in |
| | | code) of appearance | HH:MM:SS:CC (2 min. |
| | | of the element on | 50 sec. = 00:02:50:00) − |
| | | the screen | 0 = no effect |

| “PAGE” | |
|---|---|
| Description | Determines a page on the screen: - all the |
| | elements contained in the page will be displayed |
| | at the same time - all the elements contained in |
| | the other pages are not displayed |
| Hierarchy | Any terminal element of the programmes agency |
| Link-up | No |
| Property | No |
| “LIST” | |
| Description | Determines a list of menu type of headings on |
| | the screen: - all the elements contained in the |
| | page will be displayed at the same time - all the |
| | elements contained in the other pages are not |
| | displayed. |
| Hierarchy | Any terminal element of the programmes agency. |
| | - To operate correctly, the daughter hierarchy of |
| | the list must be organized as follows: - all the |
| | elements common to all the headings (the |
| | cursors, etc.) - as many structure elements as |
| | different headings, the structure element defines |
| | the concept of heading in the list; Each structure |
| | element defining a heading must in turn be |
| | organized as follows: - at the 1st level: the |
| | elements which constitute the banner of the |
| | heading, that is to say that which is displayed in |
| | the list is the one which can be selected. This |
| | level must contain no element to be displayed |
| | when the heading is selected. - at the 2nd level: |
| | in a substructure, all the elements of content, |
| | that is to say that which must be displayed when |
| | the heading is selected. |
| Link-up | No |
| Property | No |
| “SLIDE SHOW” | |
| Description | Determines a noninteractive sequence on the |
| | screen: - all the elements contained in this |
| | element form a single entity - the elements will |
| | be displayed according to the time delays |
| | advised in the “Duration” and “Pulse” properties |
| | of each element, as well as the behaviour |
| | specified in the “Usage” property. The properties |
| | of the elements contained in a slide show |
| | element are: - Pulse: indicates the instant (or |
| | time code) at which the element must appear - |
| | Duration: indicates the duration during which the |
| | element must remain displayed - Usage: |
| | specifies the behaviour which the element must |
| | have after its duration of display has elapsed: - |
| | “AnimationLoop”: indicates the restarting of |
| | animation - “AnimationShow”: indicates that the |
| | element is to remain displayed - “AnimationHide”: |
| | indicates that the element is to be erased. |
| Hierarchy | Any terminal element of the programmes agency. |
| Link-up | No |
| Property | No |
| “SCENE” | |
| Description | Determines a complete scene, that is to say an |
| | interactive screen with all its elements and |
| | behaviour. The scene is the default display |
| | element. By clicking on “Display” the agency |
| | simulates the presentation and behaviour of the |
| | screen such as on a TV screen. |
| Hierarchy | Any element of the programmes agency. |
| Link-up | No |
| Function | Description |
| Display | Initiates the Predisplay of the scene such as on |
| | a TV screen. |

| Property | Type | Description | Possible values |
|---|---|---|---|
| Usage | Menu | Determines the | List of values of the |
| | | particular | T_SCENE table: - First |
| | | usage for | screen: indicates to the |
| | | which the | generator that the |
| | | element is | application will have to |
| | | intended. | begin by displaying this |
| | | | scene - |
| | | | Screen exit: indicates to |
| | | | the generator that this |
| | | | screen is to be displayed |
| | | | when the user exits the |
| | | | application - Screen |
| | | | Information: indicates to |
| | | | the generator that this |
| | | | screen is to be displayed |
| | | | when the user presses the |
| | | | Information key. |

| “ROUTING” | |
|---|---|
| Description | Determines a navigation behaviour. The routing |
| | element makes it possible to declare which |
| | scene screen to go to after having clicked. It is |
| | also possible to add a condition thus allowing |
| | navigation to be routed as a function of the |
| | user's manipulations |
| Hierarchy | No |
| Link-up | No |

| Property | Type | Description | Possible values |
|---|---|---|---|
| Scene | Text | Name of scene | Exact name - including |
| | | to go to. | upper case/lower case - of |
| | | | a scene belonging to the |
| | | | same programme. |
| Condition | Text | Expression | The block underneath the |
| | | corresponding | property makes it possible |
| | | to a test to be | to help with the |
| | | performed to | composition of the |
| | | go to the | expression: |
| | | specified | 1) Choose the nature of the |
| | | scene. | expression to be |
| | | | constructed:-Function - |
| | | | Variable - Operator |
| | | | (cf. functions and variables |
| | | | available - ROLquery). |
| | | | 2) Select from the mini-list |
| | | | from underneath the |
| | | | appropriate expression. |
| | | | 3) Press Add or double |
| | | | click on the expression to |
| | | | copy it to the zone above. |
| | | | 4) Continue in this way until |
| | | | the expression has been |
| | | | constructed in full |
| | | | (punctuation is performed |
| | | | automatically). It is |
| | | | possible to construct |
| | | | several expressions |
| | | | starting on a new line each |
| | | | time. It is possible to |
| | | | consult the functions and |
| | | | their parameters, the |
| | | | variables and their values, |
| | | | without copying to the |
| | | | zone, by pressing the |
| | | | Continue and Return |
| | | | buttons. |

| “INSTRUCTION” | |
|---|---|
| Description | Describes one or more instructions - function - |
| | to be executed. The instruction-element makes |
| | it possible to declare mini-procedures which will |
| | have to be performed in a scene and possibly |
| | displayed on the screen in the case of input |
| | modules for example. The nature of the |
| | declarable expressions depends entirely on the |
| | generators which need to utilize them |
| | (cf. generator doc.). |
| Hierarchy | No |
| Link-up | No |

| | | | |
|---|---|---|---|
| Instruction | Text | Expression | The block underneath |
| | | corresponding to | the property makes it |
| | | one or more | possible to help with |
| | | instructions to be | the composition of |
| | | performed in the | the expression: |
| | | current scene. | 1) Choose the nature |
| | | | of the expression to |
| | | | be constructed: |
| | | | - Function - Variable |
| | | | - Operator |
| | | | (cf. functions and |
| | | | variables available - |
| | | | ROLquery). |
| | | | 2) Select from the |
| | | | mini-list from |
| | | | underneath the |
| | | | appropriate |
| | | | expression. |
| | | | 3) Press Add or |
| | | | double click on the |
| | | | expression to copy it |
| | | | to the zone above. |
| | | | 4) Continue in this |
| | | | way until the |
| | | | expression has been |
| | | | constructed in full |
| | | | (punctuation is |
| | | | performed |
| | | | automatically). It is |
| | | | possible to construct |
| | | | several expressions |
| | | | starting on a new line |
| | | | each time. It is |
| | | | possible to consult |
| | | | the functions and |
| | | | their parameters, the |
| | | | variables and their |
| | | | values, without |
| | | | copying to the zone, |
| | | | by pressing the |
| | | | Continue and Return |
| | | | buttons. |

V. The Sites Agency

The Sites agency is specialized in the distribution of the programmes created or updated with the Programmes agency. It adopts a green colour code which renders it easily recognizable from among the three agencies of the centre, and borrows all the characteristics of an agency window as explained above. Only the objects and functions required for the specific management of the sites have been inserted.

VI. The Generator and the Low-Level Language

The agencies centre 4 cooperates with a generator or transcoder 11 in a digital television applications generator which makes it possible to produce generic or nongeneric applications. Generic applications are interactive programmes whose behaviour is predictable, and whose interface and content can still be parametrized and customized.

These programmes are constructed from basic elements such as: page, picture, text, design, etc., each of these elements having well-defined properties and functionalities which are however modifiable. This set of elements thus makes it possible to implement series of screens corresponding to most of the functions required for the digital television applications: Home page, Résumé, Information, Questionnaire, etc.

The applications implementable with these types of screen cover a broad palette of standard applications: EPG, Weather, road traffic, etc., E-commerce, Catalogue, etc., Magazine, PLV, etc., Advertisements, Stock market information, etc.

The technology relies on three complementary software tools:

The agencies or agency centre 4, “front-office” which makes it possible to describe and parametrize its applications;

The generator 11, “back-office” which makes it possible to transcode the applications emanating from the agency;

The reader 26, “runtime” which makes it possible to run the application code produced by the generator 11 on the customer's station 2.

These three elements can be situated on different stations or even different sites. This is obviously the case for the reader which must be installed on each of the machines needing to broadcast the television application. Depending on the terms of installation these elements communicate either by LAN local area network, FTP Internet file transfer or satellite.

In a variant of the embodiment of FIG. 1, the low-level language generator 11 is implemented on a separate set, whilst at least one other set executes the agencies centre 4. The two sets are linked by known means, and the set carrying the generator also contains part of the agencies centre 4 which allows it to execute the tuning of the programmes with the aid of the description generator 30 and the errors manager 31 in respect of tuning.

In another variant, represented in FIG. 6, the agencies centre is divided into several groups of sets which will be described later and which execute the development or the updating of one or more interactive television applications according to a given life cycle.

The various tasks of the life cycle of a TV application are then undertaken according to the flowchart of FIG. 6:

A) the implementation of the applications

B) the generation of the applications

C) the distribution of the applications

D) the execution of the applications

E) the administration of the digital television applications according to the invention.

The implementation of the digital television applications according to the invention is performed with the agency, based on an integrated application model which merely needs to be duplicated and/or parametrized in its way. This integrated model is prepared and frozen, so as to be fully synchronized with the generator 11 which transcodes the applications thus implemented.

For each application, the agency can be a centralized or remote station, or even one which is downsized, in customer-server mode.

The agency also makes it possible to display the desired result before initiating the generation of the application. In the case of utilization in customer-server mode, only the main station can display the collection of applications implemented by several remote users.

The generation of the applications is effected with the generator 11, at the request of the agencies connected or according to a parametrizable schedule.

The generator produces a compressed transcription of the application in a format which can be run by the customer station reader, then transmits it to the stream server which distributes it over the designated network.

With each generation, the generator draws up a balance sheet which it sends back to the calling agency, so as to advise it that everything has run correctly or that errors have been noted, together with any corrections thereto.

FIG. 7 again shows the network of the embodiment of FIG. 1, in a variant tailored to several producers and several groups of customers. Each of the phases of the flowchart is plotted in the figure opposite the means of the network which are mainly used therein.

On the left of FIG. 7 are the means of the network which are mainly mobilized during phase A) of implementing the interactive television applications. Several groups 60-0 to 60-N of implementers are connected to a single production entity 63.

Each Implementation group such as the group 60-0 comprises a main agency 61 to which secondary agencies 61-1, 61-2, . . . , 61-n are connected.

Each of the secondary agencies is characterized by the possession of rights of access to the resources and to the projects available at the level of the implementation group 60-0 to which they belong which are different and reduced. The programmes and ties of the application currently being created or updated are exchanged locally under the control of the main agency 61. Each main or secondary agency comprises a deployment of the agencies centre already described with the aid of FIG. 1 et seq., the agencies manager of each of the main 61 or secondary 61-i agencies being furnished with a controller of access rights specific to each of the implementation agencies, main or secondary. This allocation is especially favourable to cooperative working in which the implementation operators work hard for chunks of television programmes, for example through audiovisual speciality.

The main agencies 61, 62 of the implementation groups 60-0 to 60-N are connected by a bidirectional link to a General agency 64 disposed in a production station 63, and they exchange the interactive television applications with it during the production process. The latter is essentially executed on a production station 63, there being a single such station in the television network of the invention.

The generator of interactive digital television applications, in a low-level language and multiplatforms, is deployed in a module 65, installed on the production station 63 and global to all the digital television users according to the invention. The General agency 64—administrative—is associated therewith for managing generation parameters, in particular automatic generation scheduling. During the production process, the administrative agency 64 assembles the various programmes and applications received from the various main agencies 61, 62 and produces a single application which it transfers to the generator 65. During production of the multiplatform low-level language codes, the generator 65 as was explained with the generator 11 and the descriptions generator 30 and the errors manager 31 returns error messages to the Administrative agency 64 which can then either solve the problem generating each error or else return a correction request message to the main implementation agency 60 or 62 concerned.

The generator 65 can receive several generation commands simultaneously. A queue is automatically created and the applications are processed one after the other. Should a rise in load occur, it is possible to install several generators such as the module 65 in parallel.

When the applications tuning process has terminated on the production station, the generator 65 transmits its code and its data to a data and streams management module 66 which executes in real time. The data and streams management module 66 is connected by a suitable channel such as a local area network or the like to a distribution system 67. The distribution of the applications is effected via the stream server 68, whose hardware and installation depend on the broadcasting supports.

The digital television operator (such as CanalSat®) is itself responsible for distributing the streams containing the applications generated.

The General agency 64 on the production system 63 references the entire distribution system so as to give the generator 65 the means of sending the transcoded applications to the stream server 68. The latter is connected to a bidirectional broadcasting channel on at least one broadcasting network such as the broadcasting networks 69-0 to 69-P. Each broadcasting network can be under the supervision of its own operator or have the same operator and comprise an unspecified number of customer stations such as stations 70-0 to 70-p of the broadcasting network 69-0.

The applications are executed by the customer station's reader (similar to the reader 26 of the customer station of FIG. 1) installed in the decoders. The reader itself is distributed by the stream, so that it can be downloaded by the decoders.

An identification system can serve to determine the network of decoders of each digital television application according to the invention. Thus, the decoders will have access only to the multichannel package relevant to them. This identification system can be managed by the General agency 64.

The entire network consisting of the digital television users according to the invention is modelled, managed and administered from the General agency 64. Each new digital television application according to the invention is the subject of a registering of its implementation stations and of its broadcasting network with the General agency 64. This organization makes it possible among other things to cater for all the monitoring and maintenance operations.

The assembly consisting of the production system 63—generator —and distribution system 67—stream server—is therefore modelled, managed and administered from the General agency 64. The configuration of the generators is registered in each implementation station 61, 62 before any remote installation.

During the execution of a television programme on one of the customer stations of one of the broadcasting networks, such as the station 70-0 of the network 69-0 for example, data and commands are returned on the broadcasting channel, these being managed by the stream server 68 which can then as a function of the execution of the programme element in progress open a given resource or stream on the data and real-time stream module 66. Such is the case when choosing a new programme, a screen, a scene or any other element, or when giving textual information.

VII. Description of an Interactive TV Application

A digital television application according to the invention consists of several types of information which are utilized according to the levels by processing means disposed on the worksets or the customer stations, the information types being:

The parameters individual to each application and valid for all the other elements making up the application: the colours, etc.;

The broadcasting parameters making it possible to identify the channel on the customer station;

The screens of the application, that is to say how each of the components appears depending on the navigation context in the application;

The data of the application, that is to say the actual content of the application: picture, text, etc.

In the subsequent description, the parameters for specifying the interactive television programme or application elements are manipulated by processing means constructed with the aid of one or more of the following means: data and address in memory, computational resource on a customer station, implementation system, production system, distribution system. The processing can consist of an edit, a create, an update, a parametrization, a save, a link or some other processing of a class or of a particular computing framework.

The parameters for defining the digital television programmes and applications according to the invention are specified in the following way:

| Information | Comment |
|---|---|
| Name | Label designating the application |
| ID | Identifies the application uniquely |
| Palette | Determines the list of 16 colours available for the |
| | TV Objects displayed on the screen |
| DVB trio | Determines the access to the application being |
| | broadcast |
| List of TV | Cf. definition of a TV scene - All the scenes - |
| scenes | screens - of this list are copiable, modifiable and |
| | customizable |

A scene consists of a collection of objects whose appearance and behaviour depend on one another screen-wise. Three types of scenes may be distinguished:

Single scenes;

Multipage scenes;

Scenes with menu-list.

A single scene is a scene all of whose component elements are present as soon as it is displayed on the screen. There is no system for scrolling pages or for choosing from among a list of elements.

A single scene is specified in the following way:

| Information | Comment |
|---|---|
| Name | Label designating the scene |
| Duration | Duration of the display of the scene (Time Out) |
| List of TV | Cf. definition of a TV Object - The objects of |
| Objects | this list are individual to the scene and remain |
| | displayed as long as the scene is played on the |
| | screen. They disappear upon a change of |
| | scene |

The elements—TV Objects—which make up this scene are basic and allow picture management, text management and design management on the screen.

A multipage scene includes a system for scrolling the pages. This type of scene makes it possible to implement consultation screens: Magazine pages, Pages of advertisements, Product details, Help pages, Legal information etc.

A multipage scene is specified in the following way:

| Information | Comment |
|---|---|
| Name | Label designating the scene |
| Duration | Duration of display of the scene (Time Out) |
| List of TV | Cf. definition of a TV Object - The objects of |
| Objects | this list are common to the scene and will |
| | remain displayed with each page |
| List of TV | Cf. definition of a TV page |
| pages | |

A menu-list scene is a single scene which includes a system making it possible to choose from among a list of elements. This type of scene makes it possible to implement selection screens: Selection of a page, Selection of a functionality, Selection of a product, of a region, of a category, Multiple choice questionnaire, Menu of a résumé, etc.

A menu-list scene is specified in the following way:

| Information | Comment |
|---|---|
| Name | Label designating the scene |
| Duration | Duration of display of the scene (Time Out) - |
| | The objects of this list are common to the |
| | scene and will remain displayed, independently |
| | of the choices made from the menu-list |
| TV menu-list | Cf. definition of a TV menu-list |
| object | |

A TV page is an object which makes it possible to manage several pages on a single screen. The pagination functions are automatically undertaken by the reader of each customer station of a digital television application according to the invention.

| Information | Comment |
|---|---|
| Name | Label designating the page |
| Duration | Duration of display of the page (Time Out) |
| List of TV | Cf. definition of a TV Object |
| Objects | |

The objects of this list are individual to the page and will be displayed with the next page (the objects common to the scene remain displayed).

A TV menu-list is an object which makes it possible to manage several choices on a single screen. The selection functions are automatically dealt with by the reader of each customer station.

| Information | Comment |
|---|---|
| Name | Label designating the list |
| List of TV | Cf. definition of a TV Object - The objects of |
| Objects | this list are common to the scene and remain |
| | displayed, independently of the changes of |
| | heading in the menu |
| List of | Cf. definition of a heading |
| headings | |

In the subsequent description, the term “highlighted” designates the property of an object of being selectable at a given instant in a given process, while generating an application or during its execution on a customer station in particular. A menu-list heading is specified by:

| Information | Comment |
|---|---|
| Name | Label designating the heading |
| List of TV | Cf. definition of a TV Object—The objects of |
| Objects | this list represent the heading on the screen. |
| | They are automatically displayed on the screen |
| | and may be highlighted |
| TV page | Cf. definition of a TV page—This object |
| object | contains all the contents associated with the |
| | heading. They are automatically displayed |
| | when the heading is highlighted |

The TV Objects are the content elements, specifically designed for televisual display. There are three of them:

The text objects;

The designs objects;

The pictures objects.

Each TV Object contains generic information (the position on the screen, the duration of display, etc.) and specific information (the colour of a text, the size of a design, etc.).

Definition of a text object

| Information | Comment |
|---|---|
| Definition of a text object | |
| Name | Label designating the text object |
| Command | Command managing the superposition of TV |
| | Objects |
| Duration | Duration of display of the text object, in |
| | MM:SS:CC |
| Start | Start of display of the text object in the page, |
| | expressed in MM:SS:CC |
| Position | Position of the text on the screen, expressed in |
| | X, Y coordinates (cf. Framing) |
| Colour | Colour of the text on the screen, from the 16 |
| | colours of the palette of the programme (cf. |
| | Palette), expressed as a line colour and |
| | background colour |
| Font | Font and size of display of the text—Expressed |
| | as a name and body of the text. The CanalSat ® |
| | decoders permit bodies of 18 and 21 |
| Framing | Determines the position of the text with respect |
| | to the point X, Y. The framing may be horizontal |
| | (left, centre, right) and vertical (top, centre, |
| | bottom) |
| Line interval | Determines the gap between two lines, in pixels |
| Character | Determines the gap between two characters, in |
| interval | pixels |
| Content | References the file containing the text |
| Definition of a design object | |
| Name | Label designating the design object |
| Command | Command managing the superposition of TV |
| | Objects |
| Duration | Duration of display of the design object, in |
| | MM:SS:CC |
| Start | Start of display of the design object in the page, |
| | expressed in MM:SS:CC |
| Position | Position of the top-left corner of the design on |
| | the screen, expressed in X, Y coordinates |
| Colour | Colour of the design on the screen, from the 16 |
| | colours of the palette of the programme (cf. |
| | Palette), expressed as an edge colour and fill-in |
| | colour |
| Size | Size of the design on the screen, in terms of |
| | height and width |
| Type of | Determines the shape of the design: squares, |
| design | rectangles, rounded edges, etc. |
| Definition of a picture object | |
| Name | Label designating the picture object |
| Command | Command managing the superposition of TV |
| | Objects |
| Duration | Duration of display of the picture object, in |
| | MM:SS:CC |
| Start | Start of display in the page, in MM:SS:CC |
| Position | Position of the top-left corner of the picture on |
| | the screen, expressed in X and Y coordinates |
| | (multiples of 16 for MPEG images) |
| Type of | Determines the way in which the picture should |
| picture | be processed on the decoder: MPEG or PIXMAP— |
| | an MPEG picture is not limited to 16 colours |
| | (cf. Palette) but is necessarily displayed behind |
| | all the other TV Objects of the screen (an MPEG |
| | picture cannot hide a text, a design or a PIXMAP |
| | picture)—A PIXMAP picture is limited to 16 |
| | colours (cf. Palette) but can be displayed above |
| | any other TV Object |
| Quality | Compression of the MPEG picture (in terms of |
| | weight or amount) |
| Content | References the file containing the picture |

There are also two other TV Objects intended for implementing the navigation and execution functions of off-the-shelf modules:

The routing objects

The instruction objects

Definition of a routing object

| Information | Comment |
|---|---|
| Definition of a routing object | |
| Name | Label designating the routing object |
| Scene | Indicates the scene to go to |
| Condition | Specifies the conditions under which one goes |
| | to the scene indicated. - For example: |
| | {KeyPressed} = OK |
| Definition of an instruction object | |
| Name | Label designating the instruction object |
| Instruction | Indicates the instruction module to be initiated. |

The instruction modules are predefined and operational, only the parameters are modifiable by the user. Exemplary modules are:

Connection, Message, Payment, Zapping, etc.

VIII. Low-Level Language and Markers

The multiplatform generator or transcoder of the invention operates according to a low-level language, distinguishing the manner of operation of the codes generator (generator 12—FIG. 1) which produces the user interfaces, and the manner of operation of the data generator (generator 14—FIG. 1) which produces the contents. Each digital television application is therefore transcoded into lines of codes by a generator or transcoder configured as a function of the target digital television platform.

The digital television programme is therefore chopped into unit blocks compatible with the constraints of the target systems (digital television platforms marketed as OpenTV® or StreamCast®). Each unit block corresponds to a scene such as was already described above and comprises a plurality of programme lines in low-level language produced by the generator or transcoder.

Each television programme line comprises at least one of the following elements:

identification;

type;

content;

properties;

link-ups.

The type element is a combination of the following information:

if the object concerned is “highlightable”, simply displayable or if it concerns another type of object (function, routing, instruction, etc.);

if the object is unitary (text object, design object, picture object, etc.) or multiple (slide show, page, list, table, menu-list, TV page, multipage, etc.).

The identification element makes it possible to pinpoint the typed object in the interactive television programme. It is unique for each typed object.

The content element reproduces the contents of the typed object. These are produced by the data generator (generator 14—FIG. 1).

The properties element reproduces the properties of the programmed object in the interactive television programme unit block.

The link-ups element reproduces the list of references linked with the programmed typed object in the interactive television programme unit block. Each link-up corresponds to a dependent object or to a content of the object to which it is attached such as the elements of a scene or of a page, the highlighting of a “highlightable” element, an action to be implemented from the customer station, etc.

The unit objects of the interactive television programmes correspond to analogous objects with the same name which were already described at the level of the agencies and of the generator. These are videos, sounds, pictures (MPEG or OSD), texts, designs, TV channels.

The unit multiple objects of the interactive television programmes correspond to analogous objects of the same name which were already described at the level of the agencies and of the generator. These are slide shows, TV pages, TV lists, tables, trees.

Other objects are reserved for the management of scenes. These are scenes objects, single scenes, multipage scenes, menu-list scenes.

Other objects are reserved for the management of functions. These are routing and instruction objects. In this way the collection of objects contained in the programmes is transcoded into a low-level language directly utilizable on the customer stations regardless of the type of platform deployed.

1. Digital television network, of the kind comprising at least one broadcaster computer comprising data storage means and means for transmitting digital television applications, and at least one device for executing at least one digital television application, characterized in that it comprises:
an agencies centre (4) installed on at least the broadcaster computer (1) so as to create, modify and/or broadcast a television application;
a transcoder or generator (11) for transcoding the digital television applications emanating from the agencies centre (4);
customer stations or consoles (2) for which the applications emanating from the transcoder (11) and broadcast by at least one broadcasting channel (3) are destined.

2. Network according to claim 1, characterized in that the agencies centre (4) comprises:
an agencies manager comprising a means of activating one at least of the agencies;
a media agency (41) comprising means for editing, in particular retrieving means, centralizing means, and archiving means, and means for organizing the elements intended to make up at least one digital television application,
a programmes agency (42) comprising means for composing a digital television application according to a predefinable tree and predefinable navigation, means for updating an application and means for determining broadcasting rules cooperating with means for producing programme execution lists (playlists) and with means for indexing and archiving the programmes and/or execution lists;
a sites agency (43) comprising means for distributing and means for broadcasting programmes created or updated in the programmes agency.

3. Network according to claim 2, characterized in that each agency (41-43) comprises:
a menu bar (45);
a hierarchical list (46);
a properties zone (48) for the elements selected from the agency;
a contents display zone (47).

4. Network according to claim 3, characterized in that the properties zone comprises:
a zone of types of elements to be selected,
a zone for editing the name of the element to be selected;
a zone for editing the values of the properties of the selected element.

5. Network according to claim 3, characterized in that the content display zone comprises control means for selecting a mode of display in Table form, in Zoom form, in Caption form and in single or multiple Selection mode.

6. Network according to one of claims 2 to 5, characterized in that the agencies manager also comprises an access rights manager which limits access of the agencies centre to the resources and target profiles according to the set where it is installed.

7. Network according to claim 2, characterized in that the media agency comprises means for executing one at least of the following functions:
ASSOCIATE: for filling in an element of another agency with the content of the medium;
EDIT: for modifying the content of the medium;
REPLACE: for changing the physical file of the medium.

8. Network according to claim 7, characterized in that the media agency also comprises means for executing at least one of the following functions: Display, New, New/Folder, New/Medium, Rename/Modify, Delete, Copy, Duplicate, Move, Export, Import, Add, Add/Video, Add/Picture, Add/Audio, Add/Text, Add/File, Replace.

9. Network according to claim 7 or 8, characterized in that the media agency comprises means for processing one at least of the following objects: Folder, Video, Picture, Sound, Text, Internet file, database file.

10. Network according to claim 2, characterized in that the programmes agency comprises means for executing one at least of the following functions:
GENERATE for initiating the generation of the source code and sending it to the generator;
DISPLAY for displaying the scene such as on a TV screen;
MEDIA AGENCY for opening the media agency while automatically pointing to the medium associated with the current element;
CHANGE MEDIUM for selecting another medium from the media agency and associating it with the current element;
EDIT THE CONTENT for creating or modifying the content of the associated medium and hence of the current element;
EMPTY THE CONTENT for breaking the link-up between associated medium and the current element.

11. Network according to claim 10, characterized in that the programmes agency also comprises means for executing at least one of the following functions: Display, New, New/Folder, New/Element, New/Programme, Rename/Modify, Delete, Delete the link-ups, Copy, Paste, Duplicate, Move, Export, Import, Medium, Content, and others still.

12. Network according to claim 10 or 11, characterized in that the programmes agency comprises means for processing one at least of the following objects: Folder, PLAYLIST execution list, TIMED PLAYLIST synchronized execution list, “CITYLINE” interactive directory, Catalogue, Module for executing programme lists (JUKE-BOX), Advertisements module (ADS-INSERT), Training, Module for managing stock market programmes (INFO-STOCK), Weather Services, electronic commerce (e-commerce), electronic banking (e-bank), electronic magazine (e-zine), and others still.

13. Network according to claim 10, 11 or 12, characterized in that the programmes agency comprises means for processing one at least of the following elements:
Structure, Video, Sound, Picture, Text, Design, Page, List, Slide Show, Scene, Routing, Instruction, and others still.

14. Network according to claim 1, characterized in that the agencies centre (4) and the generator (11) are installed on at least two separate sets or stations connected by a communications network.

15. Network according to claims 6 and 14, characterized in that the agencies centre (4) is distributed between at least one main agency (61) and one or more secondary agencies (61-1 to 61-n) on at least one implementation system.

16. Network according to claim 15, characterized in that the codes generator (65) cooperates in a production system (63) with a General agency (64) for the generation of the applications and with a module for managing the data and real-time streams (66).

17. Network according to claim 16, characterized in that the production system (63) is connected by a bidirectional link with a Distribution system (67) comprising in particular a stream server (68) itself connected to at least one broadcasting network (69-0 to 69-P) with customer stations (70-0 to 70-p).

18. Network according to one of the preceding claims, characterized in that the codes generator (11, 65) comprises means for processing each digital television application, which itself comprises:
means for processing parameters individual to each application and valid for all the other component elements such as TV Objects;
means for processing broadcasting parameters making it possible to identify the channel on the customer station;
means for processing screens of the application;
means for processing data of the application.

19. Network according to the preceding claim, characterized in that the means for processing data of the application comprise:
means for processing an application Name;
means for processing an application ID identifier;
means for processing a Palette identifying the colours of TV Objects displayed;
means for processing a code for access to the application being broadcast (DVB trio);
means for processing a List of TV scenes each of a type chosen from among in particular:
single scenes;
multipage scenes;
scenes with menu-list.

20. Network according to claim 19, characterized in that the means for processing a list of TV scenes also comprise means for processing at least one single scene which comprise:
means for processing a Name designating the scene;
means for processing a Duration of display of the scene;
means for processing a List of TV Objects making up the scene.

21. Network according to claim 19, characterized in that the means for processing a list of TV scenes also comprise means for processing at least one multipage scene which comprise:
means for processing a Name designating the scene;
means for processing a Duration of display of the scene;
means for processing a List of TV Objects making up at least one page of the scene;
means for processing a List of TV pages making up the scene.

22. Network according to claim 19, characterized in that the means for processing a list of TV scenes also comprise means for processing at least one multipage scene which comprise:
means for processing a Name designating the scene;
means for processing a Duration of display of the scene;
means for processing a List of TV Objects making up at least one page of the scene;
means for processing a List of TV menu-lists making up the scene.

23. Network according to claim 21, characterized in that the means for processing a List of TV pages making up the scene comprise means for processing at least one TV page which comprise:
means for processing the Name designating the TV page;
means for processing a Duration of display of the TV page;
means for processing a List of TV Objects individual to the TV page.

24. Network according to claim 22, characterized in that the means for processing a List of TV menu-lists making up the scene comprise means for processing at least one TV menu-list which comprise:
means for processing a List name of the TV menu-list;
means for processing a List of TV headings;
means for processing a List of TV Objects individual to the TV scene with which the TV menu-list is associated.

25. Network according to claim 24, characterized in that the means for processing a List of TV headings also comprise:
means for processing a heading Name of the associated TV menu-list;
means for processing a List of TV Objects representing the heading;
means for processing a TV Object containing the TV page definition associated with the heading.

26. Network according to one of claims 19 to 25, characterized in that the means for processing a TV Object or lists of TV Objects manipulate one of the types of TV Objects selected from among: text objects, design objects, picture objects, -routing objects, instruction objects.

27. Network according to claim 1, characterized in that the generator or transcoder comprises means for splitting into unit blocks compatible with the constraints of the target systems the programmes emanating from the implementation and/or production agencies, each unit block corresponding to a scene, and in that it comprises means for producing as a function of each unit block a plurality of programme lines in low-level language, each television programme line comprising at least one of the following elements:
identification;
type;
content;
properties;
link-ups.

28. Network according to claim 1, characterized in that the agencies centre (4) or the trancoder or generator (11) comprise means for calling (function <<Edit the content>>) resources of a specific operating system upon any of the stations in which the network is installed.

29. Network according to claim 2, characterized in that the agencies (41, 42, 43) cooperate in a memory for static data (8) in which is written at least one interactive television application model so that an interactive television application can be build, based on selection of an inteactive television application model and activation of icons and pop-up menus to set up the inteactive television application model.

30. Network according to claim 2, characterized in that the centre agencies (4) is producing an interactive television application which is presented to an input of a task descriptions generator (30) like a XML compiler, an output of which is connected to the transcoder (11) suited to a specific platform (StreamCast®, OpenTV®, MediaHighway®) under which a customer station (2) is running and in that the transcoder comprises a trial transcoding output connected to a correcting input of an error manager module (31) so that the interactive television application can be corrected.

31. Network according to claim 15, characterized in that the the agencies manager in any of the main (61) or secondary (61-i) agencies is comprising a specific access rights manager which limits access of the agencies to the available ressources and projects, to favourish cooperative working, the various agencies (60-0 - 60-N 61, 61-1 - 61-i, 62, 62-i) being connected by a bidirectional link.
